(19) United States
(12) Patent Application Publication
(10) Pub. No.: US 2014/0095352 A1
(43) Pub. Date: Apr. 3, 2014

(54) ONLINE MARKETPLACE FOR USE BY AUTHORIZED SELLERS FOR SELLING IN LOCATIONS

(71) Applicant: MICROSOFT CORPORATION, Redmond, WA (US)

(72) Inventors: Zachary Woodall, Sammamish, WA (US); Mary K. Newcomer Williams, Issaquah, WA (US); Ashish Wahi, Seattle, WA (US); Kurt Weber, Seattle, WA (US); Todd Biggs, Kirkland, WA (US)

(73) Assignee: Microsoft Corporation, Redmond, WA (US)

(21) Appl. No.: 13/732,098

(22) Filed: Dec. 31, 2012

Related U.S. Application Data
(60) Provisional application No. 61/707,732, filed on Sep. 28, 2012.

(51) Int. Cl. G06Q 30/06

(52) U.S. Cl. CPC G06Q 30/0609; G06Q 30/0623
USPC 705/26.35

(57) ABSTRACT

Disclosed herein are representative embodiments of tools and techniques for facilitating the sale of products for sellers using an online marketplace. According to one exemplary technique, a request for product information for a product is received from a device. Also, the product information is determined in part by determining that the product is for sale in a location and determining a category of the product. Additionally an online marketplace sends the product information that includes seller information for a seller that is legally authorized to sell the product in the location. The seller information includes identification information for the seller.

### CROSS REFERENCE TO RELATED APPLICATION

This application claims the benefit of U.S. Provisional Patent Application No. 61/707,732, filed on Sep. 28, 2012, entitled “ONLINE MARKETPLACE FOR USE BY AUTHORIZED SELLERS FOR SELLING IN LOCATIONS,” which is hereby incorporated herein by reference.

### BACKGROUND

As the use of mobile devices have become more prevalent, store models have been developed for selling content for use with mobile devices. Although these traditional store models have been used to sell content for mobile devices, these store models have limitations, including legal limitations for selling and the need to replicate store infrastructure to sell content in different countries.

### SUMMARY

Among other innovations described herein, this disclosure presents various representative embodiments of tools and techniques for facilitating the sale of products in locations for authorized sellers using an online marketplace.

In one embodiment, an online marketplace receives a request for product information from a device located in a location where the product is to be sold. The online marketplace determines the product information based on conditions for selling the product in the location. The product information is determined in part by determining that the product is for sale in the location and by determining a category for the product. Additionally, the online marketplace sends the determined product information to the device for display. The product information includes seller information for a seller that is legally authorized to sell the product in the location. The seller information includes identification information for the seller. Also, the online marketplace facilitates a financial transaction for a sale of the product for the seller. The processing of the financial transaction includes receiving a request from the device to purchase the product at the online marketplace that includes purchase information for a consumer. Responsive to receiving the request to purchase the product, the online marketplace determines a billing code for the seller that is associated with a payment service and/or payment instrument. Additionally, the online marketplace authorizes the use of the billing code to have the payment service transfer funds to an account of the seller as payment for the sale of the product.

According to another exemplary technique, a request for product information for a product is received from a device. The product information is determined in part by determining that the product is for sale in a location, and determining a category of the product. Additionally an online marketplace sends the product information which includes seller information for a seller that is legally authorized to sell the product in the location. The seller information includes identification information for the seller.

In another exemplary technique, a device sends a request for product information for a product to an online marketplace. The device receives the product information that includes seller information for a seller that is legally authorized to sell the product in a location. Using the seller information, information that indicates that the product is sold by the seller is displayed by the device. Additionally, purchase information is sent to the online marketplace for transferring funds to an account of the seller to purchase the product from the seller.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the technologies will become more apparent from the following detailed description, which proceeds with reference to the accompanying figures.

### BRIEF DESCRIPTION OF THE DRAWINGS

FIG. 1 is a diagram illustrating an exemplary online marketplace that can facilitate sales of one or more products for one or more sellers in part by sending product information.

FIG. 2 is a flow diagram of an exemplary method for facilitating sales of one or more products for one or more sellers in part by sending product information.

FIG. 3 is a diagram illustrating an exemplary system for processing a financial transaction for a sale of a product for a seller.

FIG. 4 is a flow diagram of an exemplary method for processing a financial transaction for a seller.

FIG. 5 is a flowchart for an exemplary method for processing a financial transaction for a seller as part of a sale of a product.

FIG. 6 is a diagram illustrating an exemplary product information screen for an online marketplace that identifies a legally authorized seller of a product as part of information for the product.

FIG. 7 is a diagram illustrating an exemplary purchase confirmation screen for an online marketplace that identifies a legally authorized seller of a product as part of a purchase confirmation for a sale of a product.

FIG. 8 is a flow diagram of an exemplary method for purchasing a product from an identified seller legally authorized to sell the product by sending purchase information to an online marketplace.

FIG. 9 is a schematic diagram depicting an exemplary mobile device with which at least some of the disclosed embodiments can be implemented.

FIG. 10 is a schematic diagram illustrating a generalized example of a suitable implementation environment for at least some of the disclosed embodiments.

FIG. 11 is a schematic diagram illustrating a generalized example of a suitable computing environment for at least some of the disclosed embodiments.

### DETAILED DESCRIPTION

### Exemplary System for Providing Product Information to Facilitate a Sale for a Seller

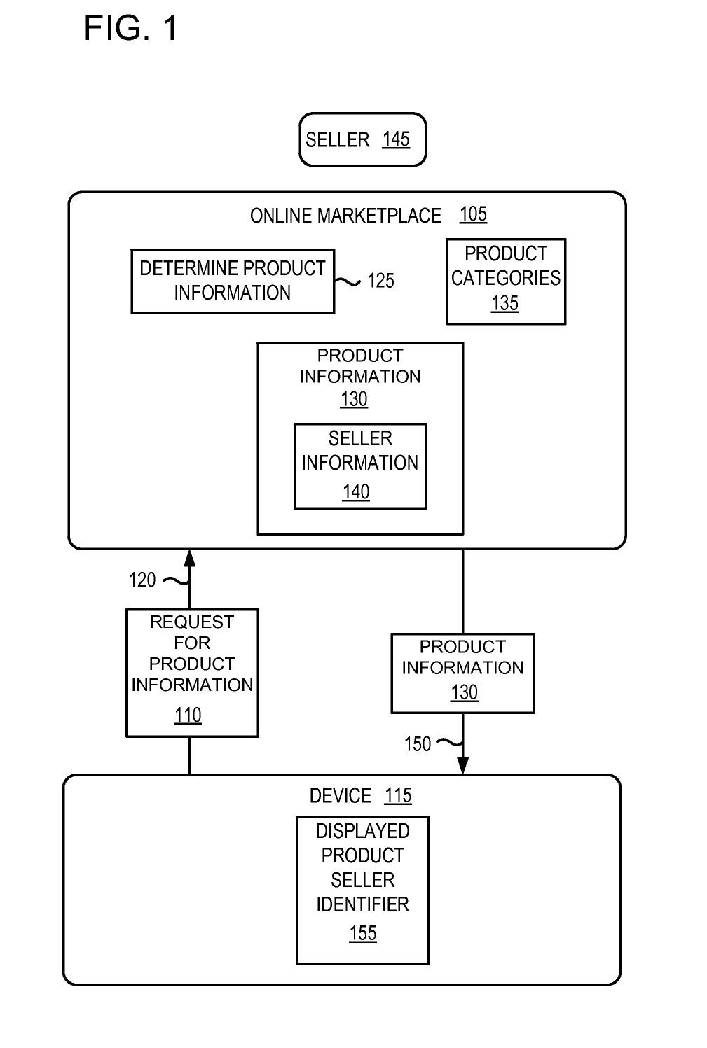

FIG. 1 is a diagram illustrating an exemplary online marketplace 105 that can facilitate sales of one or more products for one or more sellers in part by sending product information. In FIG. 1, the online marketplace 105 receives a request for product information 110 for a product from the device 115 at 120. At 125, product information 130 is determined for the product based on conditions for selling the product in a location associated with a customer and/or the device. For example, conditions for selling the product can include that the device and/or customer is in a country and/or a city that has a government that regulates the sale of the product and/or allows sellers to sell the product under one or more licenses. The product is categorized at the online marketplace 105 into one or more categories, such as a category 135, based on conditions for the sale of the product in a location where the product is to be and/or is being sold.

The determined product information 130 for the location where the product is to be sold includes seller information 140 that can be used by the device 115 to identify a seller 145 as being the seller of the product. The seller 145 is legally authorized to sell the product in the location associated with the device. For example, the seller 145 can have a license to sell the product in the country and/or city where the product is to be sold and/or where the device and/or customer is designated as being located.

The product information 130 is sent from the online marketplace 105 to the device 115 at 150. The device 115 uses the product information 130 to display information that identifies the seller 145 as the seller of the product as shown at 155. The seller 145 can use the services of the online marketplace 105 to sell products. The seller 145 can be the selling, licensed, or distributing entity or party with legal rights and/or access to licenses and/or rights for conducting a store for selling the products in the location. Using the infrastructure and services of an online marketplace to sell products, an authorized seller can sell the products in the location as authorized without having to create a different store infrastructure for selling in the location. The online marketplace can maintain a common look and feel to customers for selling products for one or more sellers in one or more locations. In some implementations, sales of products by a seller through an online marketplace can be conducted such that consumers, customers, businesses, governing bodies, tax authorities, or others can recognize the seller as the selling entity from which the product has been delivered to the customers such as individual consumers and/or businesses.

### Exemplary Method for Providing Product Information to Facilitate a Sale for a Seller

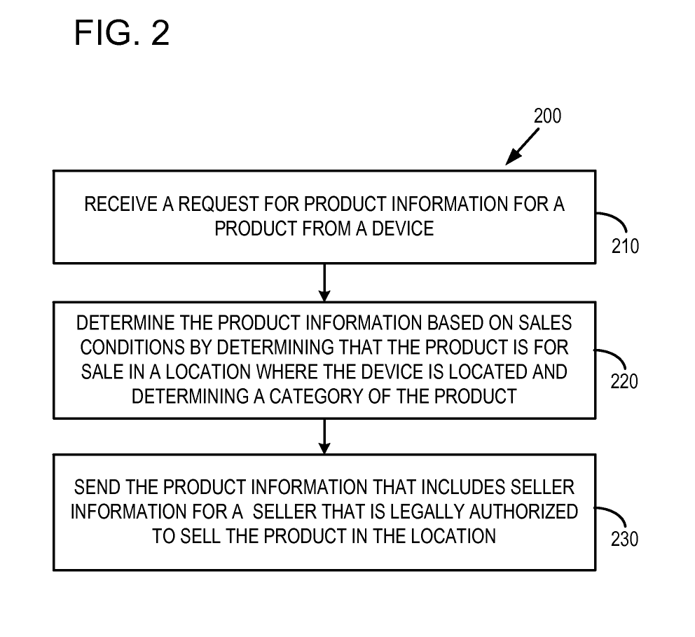

FIG. 2 is a flow diagram of an exemplary method 200 for facilitating sales of one or more products for one or more sellers in one or more locations in part by sending product information.

In FIG. 2, a request for product information for a product is received from a device at 210. For example, an online marketplace can receive a request for product information for a product that is to be sold within a location using a device. In some implementations, the device can be designated as being within the location, associated with the location, or being within the location. For example, a customer who is using the device to purchase the product using the online marketplace can indicate using the device that the customer and/or device is located within the location. The indication of the location of the customer and/or device can be communicated to and received by the online marketplace from the device.

The online marketplace can facilitate sales of one or more products for one or more sellers in the location where the device is designated to be located. The online marketplace can provide technology services to a seller to facilitate the sale of a product in one or more locations. For example, the online marketplace can be an online store, for electronic content or other products, that is capable of selling products in some countries but may not be able to sell products in one or more other countries because of legal regulations, rules, laws, or other like authorities.

The online marketplace can have localizing functionality that can facilitate sales of products as a store for other legally authorized sellers in a way that complies with regulations, laws, or rules for selling the products within a location. The localization functionality of the online marketplace can provide one or more services to sellers in a location to use the online marketplace as a store for customers to purchase the products sold by the sellers. The services provided to the sellers by the online marketplace can include use of technology infrastructure, marketing, sales facilitation services, or other store services of the online marketplace.

In some implementations, the online marketplace provides one or more services to the seller for facilitating the sale of the product that can include cataloguing a product, processing a financial transaction for the sale of a product, services for user authentication for access (e.g., secure access) to the online marketplace, services for user authentication for a purchase (e.g., a secure purchase) of the product and/or technical distribution of the product, distributing the product, unlocking the product, fulfillment of content for selling, or other like services. In some implementations, the authorized sellers can pay the online marketplace and/or operators of the online marketplace a fee for the services provided by the online marketplace. In some implementations, a seller can contract with the online marketplace to sell products through the online marketplace.

The online marketplace can maintain a catalogue of the one or more products or services for marketing and sale by one or more sellers. In some implementations, the one or more products that can be sold using the online marketplace can include software products and/or non-software products. For example, a product that can be sold using the online market place can include a software product such as a software application, mobile device application, gaming application, productivity application, media application, non-gaming application, or the like. In some implementations, the product sold is not a software item. In some implementations, the online marketplace can store and deliver and/or provide the product for download. In some implementations, the online marketplace does not store and distributed the product. For example, a seller can store and deliver and/or distribute the product after the product can been purchased using the online marketplace. In some implementations, the online marketplace can comprise a computing system that can include one or more computing devices. The online marketplace can be accessible using one or more communications connections and one or more networking and/or internet technologies. In some implementations, the online marketplace can be accessed using a software client and/or web browser of a device.

With reference to FIG. 2 at 220, the product information for the product is determined based on conditions for selling the product. In some implementations, conditions for selling the product can be based on laws, regulations, contracts, business decisions, rules, or other like conditions. In some implementations, the conditions for selling the product can be based on the type of product, how the product is sold, how taxes of a sale of the product are handled, a payment instrument for use in selling the product, licenses for selling the product, the presence of contact information and/or licensing information upon sale or distribution of the product, the availability of a payment instrument, or other like operational conditions.

The product information determined can vary based on the conditions for selling the product. For example, if the product is to be sold in a country were the product is regulated and/or where the product can be sold by a seller that has a license and the operator of the online marketplace and/or the online marketplace does not have the license to sell the product, the product information can indicate that the legally authorized seller, which is not the online marketplace, is the selling the product.

Also for example, the product information for the product can be a first group of information based on conditions for selling the product in the first country if the product is to be sold in the first country or a second group of information based on conditions for selling the product in the second country if the product is to be sold in the second country. In some implementations, the first and second groups of information can differ in part or in whole or not differ.

In some implementations, the determining the product information can include, determining that the product is within a category. For example, a product can be categorized into one or more categories based on conditions for selling the product within a location. For example, a product can be categorized as a game application. In some implementations, the game application category can include products that include game content that can be sold in the location by sellers that have a license that authorizes the sale of the game content. Also, for example, a product can be categorized as being a non-game application that can be sold in the location by sellers that have a license that authorizes the sellers to sell non-game applications. In other implementations, products can be categorized based on other conditions such as technical specifications, product content, product price, a distribution model for the product, legal regulations for the product, or other like conditions. In some implementations, the determining that a product is included in a category can include determining that the product is associated with the category in a database or other information repository of the online marketplace.

In some implementations, the determining the product information can include determining that the product is for sale in a location where the device is located. For example, if the product is in a catalogue of the online marketplace for a location, then the product can be determined to be available for sale in the location. In some implementations, when a request for product information is received, the product associated with the request can be for sale in a catalogue for the location. A catalogue for the location can include the products that are available for sale in the location by one or more sellers using the online marketplace as a store. In some implementations, a location can be a country, a city, or the like. For example, a location can be a country or city and one or more governing bodies of the country or city can have one or more laws, rules, or regulations that regulate the sale of one or more products and/or the sellers of one or more products within the city or country.

At 230, the determined product information for the product is sent to the device. For example, the determined product information appropriate for selling the product in the location can be sent to the device responsive to the request for product information. The product information can include seller information for a seller that is legally authorized to sell the product in the location. For example, the seller can be legally authorized to sell the product in the location, because the seller has acquired and possesses a license that allows the seller to sell the product in the location. In some examples, sellers can be legally authorized to sell the product through law, regulations, licenses, or other authorizing authority. A seller can be a legal, licensed, or regulated distributer of a product and/or content into a location such as a country or a city. For example, for sales of products in the People's Republic of China, a seller can have acquired one or more of an Internet Content Provider license, an Internet Culture Operation license, Internet Game Publishing license, or other license. In some implementations, displaying and/or providing information that the product is sold by an identified seller can be done because of and in compliance with a law, rule, regulation, or other authority for the sale and/or marketing of the product. In some implementations, displaying and/or providing product information for a product in selling the product can be done because of and in compliance with a law, rule, regulation, or other authority for the sale and/or marketing of the product.

### Exemplary System for Processing a Financial Transaction to Facilitate a Sale for a Seller

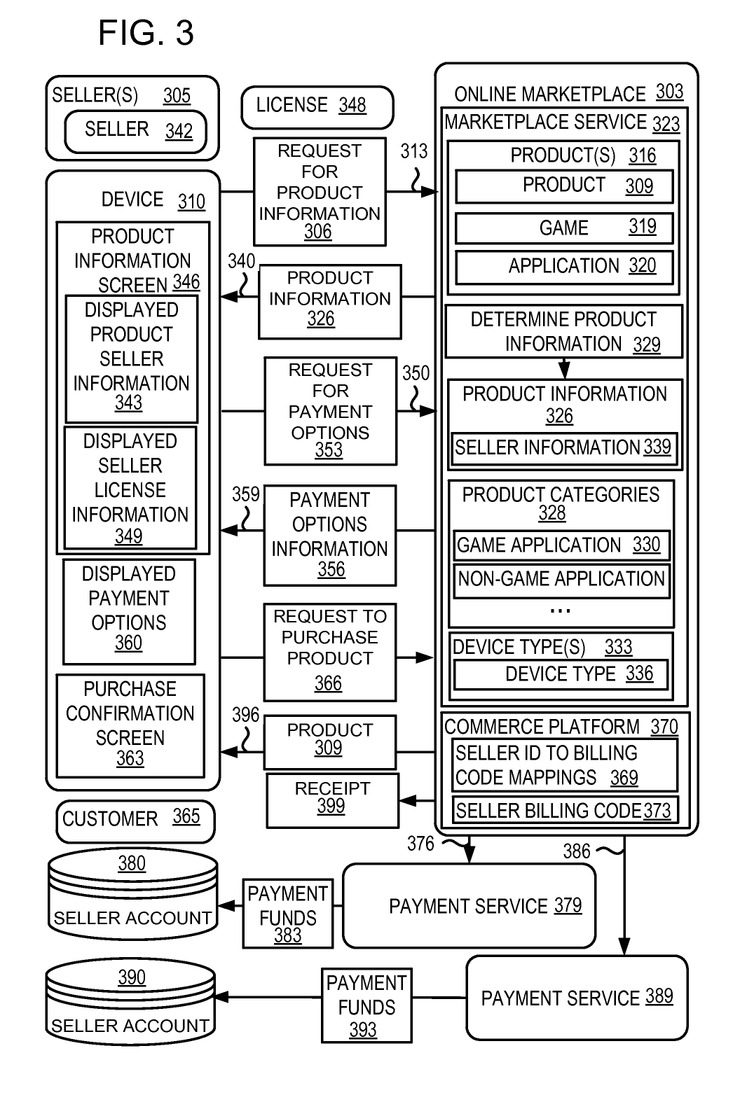

FIG. 3 is a diagram illustrating an exemplary system for processing a financial transaction for a sale of a product as part of a service for a seller. In FIG. 3, an online marketplace 303 receives a request for product information 306 for a product 309 from a device 310 as shown at 313. The online marketplace 303 can facilitate a sale for one or more sellers 305 of one or more products 316 such as product 309, game application 319, or application 320. In some implementations, a product can include content such as an application, a game, an in-application product (e.g., game levels, in-game items, avatar items, or the like), an in-application service (e.g., a video or magazine subscription or the like), a book, music, media, video, news, coupons, advertising, credits, prepaid cards, services, data access and/or storage services, or the like. In some implementations, an online marketplace can be a store for content and/or products for mobile devices, tablet computers, personal computers, or other computing devices.

The one or more products 316 can be made, published, or developed by one or more publishers. The online marketplace 303 can associate a publisher of products with one or more sellers that are legally authorized to sell the publisher's products in a location. The online marketplace can store these associations between publishers and sellers in a database or other data store. The online marketplace can store associations between products and sellers that are legally authorized to sell the products based on conditions for selling the products in a location, and these associations can be stored in a database or other data store.

The online marketplace can store information about the one or more sellers. The information about the one or more sellers can include one or more of a seller's name, seller contact information, the seller's address, a license acquired by the seller, or other like information for a seller.

The online marketplace can also store information about the one or more products 316 in a database or other data store. For example, the stored information about the one or more products 316 can include product information about the product that is to be displayed in a device for customer viewing and/or can include information about one or more conditions for selling the product in one or more locations.

The request for product information 306 can be received at the online marketplace 303 by a marketplace service 323. Responsive to receiving the request for product information 306, the marketplace service 323 determines product information 326 for the product 309 for the designated location at 329 based on one or more conditions for selling the product in the location. The marketplace service 323 determines the product information 326 in part by determining that the product 309 is within a category of one or more categories 328 using data stored about the product. The stored information about the product indicates that the product is designated as being within a category. The product 309 is determined to be included in a category 330 that is a category for applications that include game content, as the product 309 includes game content.

The marketplace service 323 determines that the product information 309 in part by determining that the product 309 is for sale in a location because the product 309 is being sold in a catalogue of products that are for sale in the location. Also, the marketplace service 323 determines the product information 309 in part by determining that the device 310 is of a type of one or more device types 333. The device 309 is determined to be of a type 336 that can support and/or is compatible with the sale of the product 309 in the location using the online marketplace.

The appropriate product information 326 is determined at 329 based on the device 310 being of type 336, the product 309 being within category 328, and the product being sold within the location associated with the catalogue it is included in. The online marketplace associates these conditions with the group of information in the determined product information 326. The product information 326 includes seller information 339 for a seller 342 that is legally authorized to sell the product 309 within the location where the product 309 is to be sold. The online marketplace 303 includes the seller information 339 for the seller 342 because the online marketplace has a stored association between the seller and the product for the location the product is to be sold.

The online marketplace communicates the product information 326 to the device 310 at 340. As shown at 343, the seller information 339 is used by the device and/or software of the device to render and display information that identifies the seller as being the seller of the product in a product information screen 346. The product information can also include information about a license 348 that the seller 342 has to sell the product 309 and the license information can be displayed by the device 310 in the product information screen 346 as shown at 349.

At 350, the online marketplace receives a request for payment options 353 sent by the device 310. The request for payment instrument options 353 is sent responsive to a user selection to purchase the product 309 in a user interface of the device 310.

As shown at 359, responsive to the request for payment instrument options 353, the online marketplace 303 sends determined payment instrument option information 356 listing payment instruments that can be selected and/or used to purchase the product 309 in the location through the online marketplace.

As shown at 360, the payment instrument option information 356 is used to display a listing of the payment instruments that are available for use as options for selection in a user interface by a customer 365 using the device 310. Using a displayed purchase confirmation screen 363, a customer 365 using the device 310 can use a user interface of the device to confirm that the customer 365 authorizes the purchase of the product and that an account of the customer 365 can be charged the applicable fees for the purchase such as the price of the product, taxes, transaction fees, or other applicable fees.

Responsive to a confirmation to purchase the product that is received at the device 310, the device 310 sends a request 366 to purchase the product 309 to the online marketplace 303. A commerce platform of the online marketplace 303 can have mapping information 369 that maps seller identifiers to billing codes for the sellers. A billing code for a seller can be used with a payment instrument to conduct a transfer of funds to an account of the seller associated with the billing code.

Responsive to receiving the request 366 to purchase the product 309, the online marketplace 303 uses the mapping information 369 to determine a billing code 373 mapped to the identifier for the seller 342 of the product 309. At 376, the commerce platform 370 of the online marketplace 303 instructs and/or authorizes the payment service 379 to use the billing code 369 associated with the seller's account 380 to transfer funds 383 to the seller's account 380 for payment for the sale of the product 309. In some implementations, other financial information associated with the seller's account can be used to transfer funds to the seller's account.

The commerce platform 370 can authorize a financial transaction for the purchase of one or more products for one or more sellers to one or more customers. At 386, another financial transaction is authorized by the commerce platform 370 to purchase another product which is application 320. To process the financial transaction, the commerce platform 370 instructs and/or authorizes the payment service 389 to use a billing code for the seller of the application 320, that is associated with an account 390 for the seller of the application 320, to transfer funds 393 from a customer account to the seller's account 390 for payment for the sale of the product 320. In some implementations, various sellers can use the same payment service or different payment services to transfer funds for payment for sales of the respective sellers' products to respective customers.

The online marketplace 303 can store products of the one or more products 316 for download and/or delivering to one or more customers. At 396, the product 309 is downloaded for installation and use on the device 310. The product 309 is included in a catalogue of products that are available for downloading from the online marketplace for a location. For example, the application can be downloaded by the computing device 310 using a communications connection and or one or more internet technologies and/or networking technologies. In some implementations, the product can be downloaded to the computing device 310 after the product 309 has been purchased and/or authorized to be downloaded to the computing device. After the product 309 has been purchased, the online marketplace can provide a receipt 399 to the purchasing customer 365. The receipt 399 can include seller information including information that identifies the seller as having sold the product. The receipt 399 can also include contact information for the seller, a license number for the seller, or other information associated with the product and/or sale of the product. In some implementations, a receipt is sent to a customer in a loggable format such as in an email, in a text message, on paper, or other loggable format.

### Exemplary Method for Processing a Financial Transaction to Facilitate a Sale for a Seller

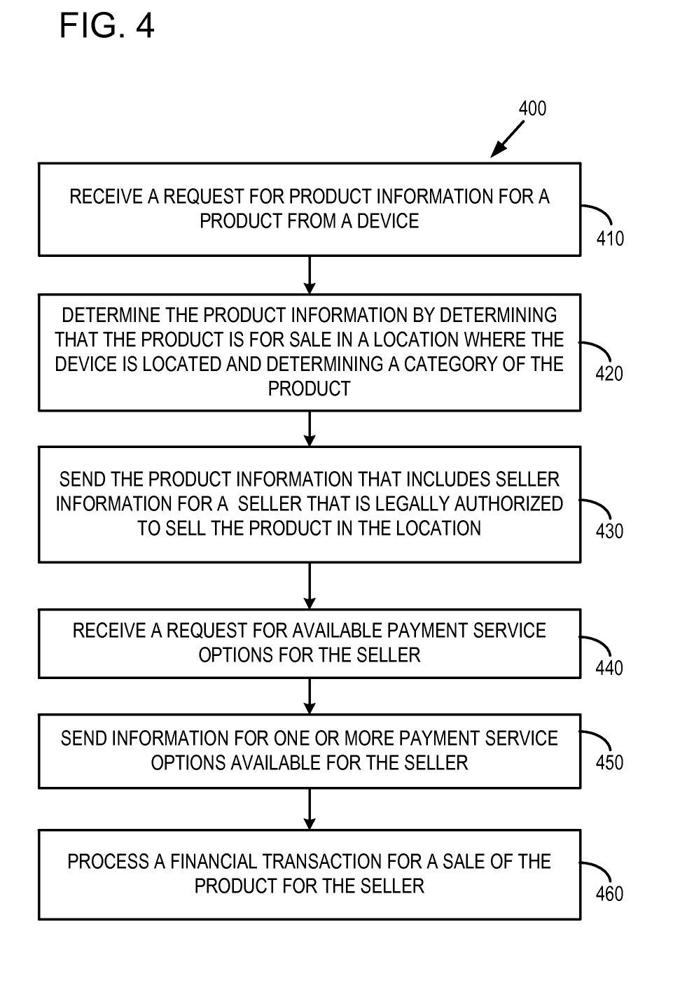

FIG. 4 is a flow diagram of an exemplary method 400 for processing a financial transaction as part of a sales service for a seller. In FIG. 4, a request for product information for a product is received from a device at 410. For example, a device can have a communications connection with the online marketplace, and the device can send a request for product information for an identified product that can be received by the online marketplace. The product information can be used by the device to display details for the product to a user of the device. In some implementations, the product can be an application such as a game application, a non-game application, or other application.

At 420, the product information for the product is determined based on conditions for selling the product. For example, in response to the request for product information for the product, the online marketplace can determine appropriate product information to send to the requesting device based on conditions for selling the product within the location the device is designated as being located. In some implementations, the online marketplace can determine that the product can be legally sold within the location with a seller that is using the online marketplace as a store to sell the product.

In some implementations, the online marketplace can charge the seller a fee after a product is sold for the services provided that facilitated the sale of the product within the location. For example, after a sale of a product the seller can pay the online marketplace a fee for services provided to the seller for selling the product. In some implementations, because the seller is legally authorized to sell the products in the location, the funds (e.g., any funds) for payments of fees charged to a customer by the online marketplace for the sale of the product are deposited into a banking account for the seller and not deposited into a bank account for the online marketplace.

In some implementations, the determining the product information can include one or more of determining that the product is for sale in a location where the device is located, determining that the product is within a category, determining a type of the device, or the like. For example, the device can be of a type that can be used with the online marketplace to purchase the product from a seller authorized to sell in the location.

At 430, the product information is sent to the device. The product information including seller information for a seller that is legally authorized to sell the product in the location. For example, the seller can have a license that authorizes the seller to sell and/or distribute the product within the location. In some implementations, the product information for the product can include a unique identifier for the seller of the product, a business name of the seller of the product, a license number of a license held by the seller of the product, or contact information for the seller of the product such as a phone number of the product seller or other contact information.

At 440, a request for available payment instrument options for the seller is received. For example, using a user interface of the device, a user of the device can select an option to purchase (e.g., buy) the product and the device can send a request to the online marketplace to request one or more payment instrument options that are available in the location for use in purchasing the product. A payment instrument can be a manner of conducting payment of funds such as paying with a credit card, a check, bank card, an online payment instrument, a financial services payment instrument, bank account instrument, a payment processor instrument, bank provided payment instrument, or the like. A payment instrument can be provided by a payment service. For example, a credit card payment instrument (e.g., a credit card or the like) can be provided by a credit card payment service that processes the credit card transactions. Also for example, an online payment instrument can make payments and/or funds transfers that are conducted by an online payment service. In some implementations, the one or more payment instrument options that are available for use in purchasing the product can be supported by the online marketplace and/or the seller.

At 450, information for one or more payment instrument options available for purchasing the product is sent to the device. For example, in response to the request for available payment instrument options for the product, a listing of payment instruments that can be used to purchase the product can be determined and sent to the device. In some implementations, the online marketplace can have products associated with authorized sellers and based on the location of sale and/or a seller of the product, payment instruments available for purchasing the product in the location can be determined. The determined payment instruments can be supported for use with the online marketplace and the seller associated with and/or that sells the product in the location of sale. In some examples, sellers that sell products in a location using the online marketplace can create accounts with payment services so that the sellers are payable by customers using at least one of a group of payment instruments that the online marketplace lists as available for purchases in the location. In some implementations, a database or information repository can store information about one or more payment instrument options for selling a product in a location and the information can be retrieved to determine payment options available for the sale of a product.

The payment instruments listed in the listing of payment instruments can be options for selection at the device. The one or more payment instrument options can be selected to purchase the product. For example, using a user interface available at the device, a customer user of the device can select to use a listed payment instrument to purchase the product and use the selected payment instrument to purchase the product.

A payment instrument can be provided and/or used by a payment service to conduct financial transactions such as funds transfers. In some implementations, a seller of the product can have one or more accounts with one or more payment services that provide one or more payment instruments that are available for use to purchase the product. In some implementations, a seller can have an account with another financial institution such as a bank or other payment service that is not the payment service that provides the payment instrument, and the account can be used to transfer funds to the seller using the payment instrument provided by the payment service.

In some implementations, an account can be an account for the seller where the seller can receive funds. An account can include a bank account, an account with a financial institution, an account with a payment service, or other funds account of the like.

At 460, a financial transaction is processed for a sale of the product by the online marketplace for the seller. For example, the online marketplace can use financial information for the seller of the product to authorize a transfer of funds to an account of the seller. In some implementations, the online marketplace can determine a billing code for the seller that can be used by a payment service to transfer funds to an account of the seller. The funds can be transferred to the account of the seller from the customer. The transferred funds can be payment for the sale of the product to the customer. In some implementations, the funds are transferred from the customer such that they are transferred as authorized by the customer, on behalf of the customer, from an account with funds usable by the customer, from an account controlled by the customer, or the like. In some implementations, the online marketplace can process financial transactions on behalf of the a seller and can create a record for transactions and/or taxes by using one or more billing codes which can be used to deposit funds from a customer (e.g., a consumer and/or business) account into a banking account of the seller for payment for the sale of a product. In some implementations, the financial transaction can be processed such that the seller is the recorded legal seller of the product within the location. In some implementations, bank receipts and/or receipts from the online marketplace reflect that the seller sold the product in the country.

The online marketplace can protect information such as sensitive personally identifiable information and/or high business impact information of a seller that is stored and/or used within the online marketplace that is not accessible by the online seller. The online marketplace can automatically log information about sales, distributions, or transactions conducted by the online store for the seller, and the local seller can have accesses to the information logged by the online marketplace. In some implementations, a local seller that sells products through the online marketplace can automatically have access to financial information about sales transactions and consumer information associated with products that are sold using the online marketplace for the seller. In some implementations, the online marketplace can log sales information such as information about which products have been acquired by and/or sold to identifiable consumers and/or in what quantity.

### Exemplary Method for Processing a Financial Transaction for a Seller as Part of a Sale of a Product

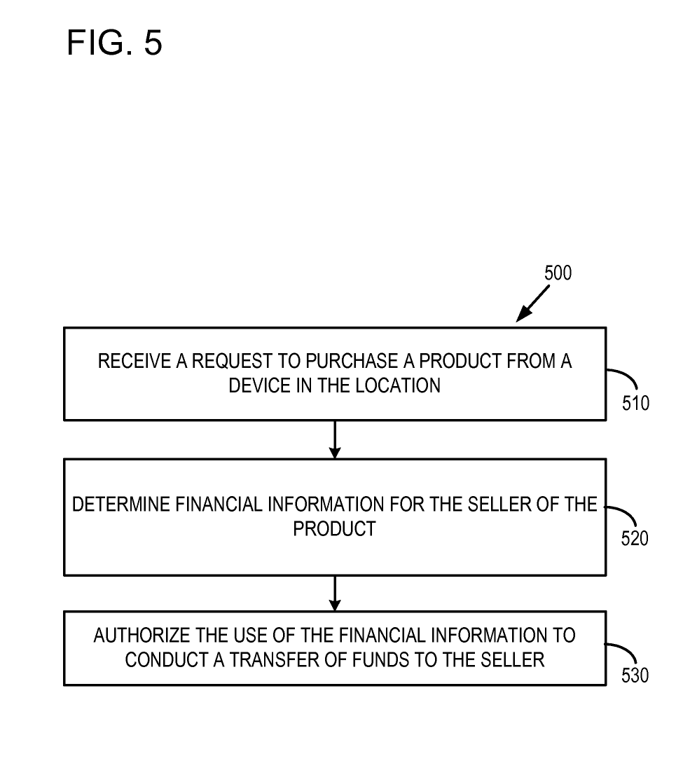

FIG. 5 is a flowchart for an exemplary method 500 for processing a financial transaction for a seller as part of a sale of a product. In FIG. 5, a request to purchase a product is received from a device in a location at 510. For example, a customer user of the device in a location can use a user interface of the device to select to purchase the product from the seller. Responsive to the selection to purchase the product, the device sends, to an online marketplace, a request to purchase the product in the location from the seller. The request to purchase the product can be sent and received over a communications connection.

At 520, financial information for the seller of the product is determined. For example, a billing code for the seller can be determined. In some implementations, an online marketplace can store a mapping of sellers to billing codes for the sellers. A billing code for a seller can be associated with a payment service and/or payment instrument and used by a payment service to transfer funds. A seller can have one or more billing codes for one or more payment services and/or payment instruments. The billing codes for a seller can be determined based on a selected payment instrument. For example, if a customer has selected and/or used a payment instrument to purchase the product, a billing code associated for use with the selected payment instrument and/or the payment service that provides the payment instrument can be determined as the billing code for the seller.

At 530, the use of the financial information is authorized to conduct a transfer of funds to the seller. For example, funds can be transferred from the customer purchasing the product to an account of the seller by a payment service. The funds for purchasing the product can be from a customer's account to the seller's account. In some implementations, the online marketplace instructs and/or authorizes the use of a billing code of the seller in conducting financial transaction. In some implementations, the online marketplace instructs and/or authorizes a payment service to use the billing code of the seller to conduct the financial transaction. In some implementations, the online marketplace instructs and/or authorizes a payment processor to use the billing code of the seller to conduct the financial transaction. A payment processor can integrate with the payment service such that funds (e.g., money) can be transferred from a customer's account (e.g., a purchaser's account) through the payment processor and deposited into the seller's account.

The online marketplace can collect and log information about the sale of a product such as transactional information, customer information, price information, sales quantity information, or other like sale information. In some implementations, the seller and/or the online marketplace can use the collected information about the sale for financial reconciliation purposes.

### Exemplary Product Information Screen for Purchasing a Product Form a Seller Through an Online Marketplace

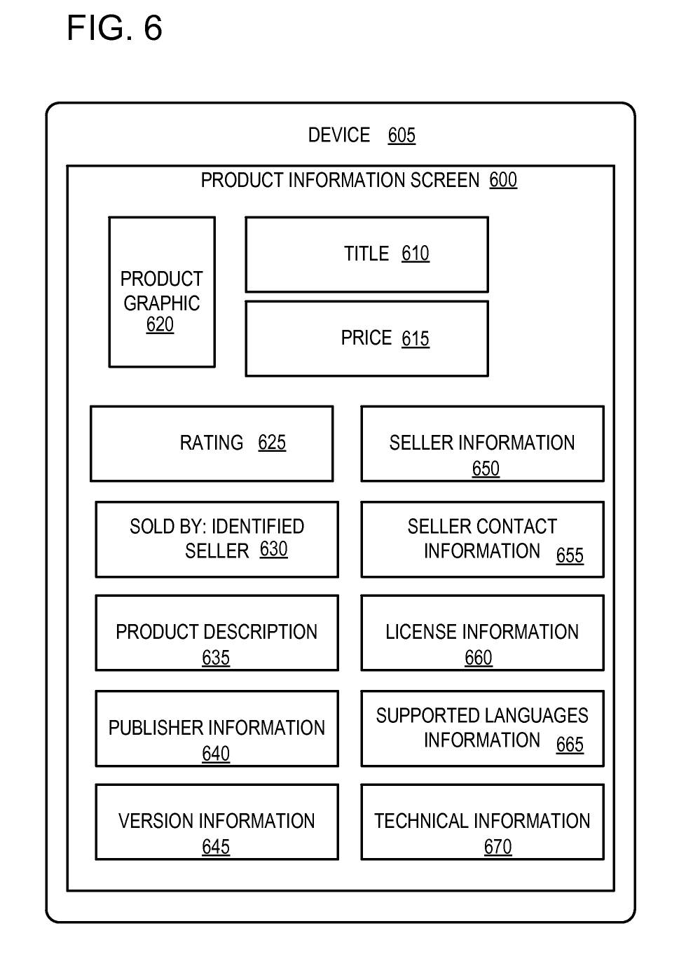

FIG. 6 is a diagram illustrating an exemplary product information screen 600 for an online marketplace that identifies a legally authorized seller of a product as part of information for the product received from an online marketplace. In FIG. 6, the product information screen 600 is rendered and displayed by device 605. The product information screen 600 can display product information for a product received from an online marketplace. The product information can include a product title 610, a product price 615, a product graphic 620, a product rating 625, sold by information 630, a product description 635, product publisher information 640, product version information 645, seller information 650, seller contact information 655, license information 660, product language information 665, or product technical information 670.

The sold by information 630 can indicate that the product is sold by a seller that is identified with displayed identification information such as a name of the seller or the like. The sold by information 630 can be displayed in one or more languages. For example, the sold by information can be displayed in one or more languages read and/or spoken in the location where the product is to be sold and/or where the customer and/or device is located. In some implementations, the displayed name of the seller is localized and/or simplified in a language used in the location of the sale of the product. In other implementations, the displayed name of the seller is not localized and/or simplified in a language used in the location of the sale of the product.

The publisher information 640 can identify a publisher, maker, or developer of the product. The seller information 650 can identify the seller of the product in one or more languages. The seller contact information 655 can include a phone number for the seller, an address of the seller, an email address for the seller, or other contact information for the seller. The license information 660 can provide information about a license that the seller possesses that legally authorizes the seller to sell the product. For example, the license information 660 can include a license identifier such as a license number, license name, or other like license identification information.

### Exemplary Purchase Confirmation Screen for Purchasing a Product from a Seller Through an Online Marketplace

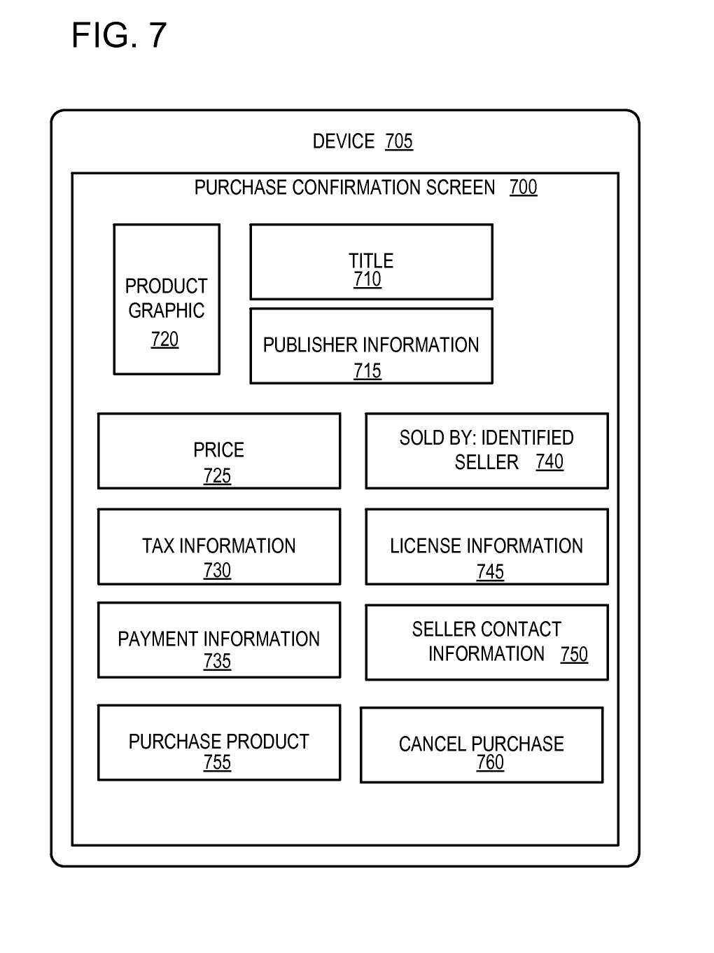

FIG. 7 is a diagram illustrating an exemplary purchase confirmation screen 700 for an online marketplace that identifies a legally authorized seller of a product as part of a purchase confirmation for a sale of a product. In FIG. 7, the purchase confirmation screen 700 is rendered and displayed by device 705. The purchase confirmation screen 700 can display product information received from an online marketplace about a product to confirm the product is to be purchased from an identified legally authorized seller. The information about the product can include a product title 710, product publisher information 715, a product graphic 720, a product price 725, tax information 730, payment information 735, sold by information 740, license information 745, or seller contact information 750. The sold by information 740 can indicate that the product is sold by a seller that is identified in the purchase confirmation screen 700. The sold by information 740 can be displayed in one or more languages. The publisher information 715 can identify a publisher, maker, or developer of the product. The license information 660 can provide information about a license that the seller possesses that legally authorizes the seller to sell the product. For example, the license information 745 can include a license identifier such as a license number, license name, or other like license identification information. The purchase confirmation screen 700 can include a purchase product option 755 that can be selected by a user to confirm that the product is to be purchased. For example, when the user selects the purchase product option 755 the device can send a request to purchase the product to the online marketplace that is associated with the purchase confirmation screen 700. The purchase confirmation screen 700 can include a cancel purchase option that can be selected by a user to indicate that the user does not desire continue with purchasing the product at the online marketplace associated with the purchase confirmation screen.

### Exemplary Method for Processing a Financial Transaction for a Seller as Part of a Sale of a Product

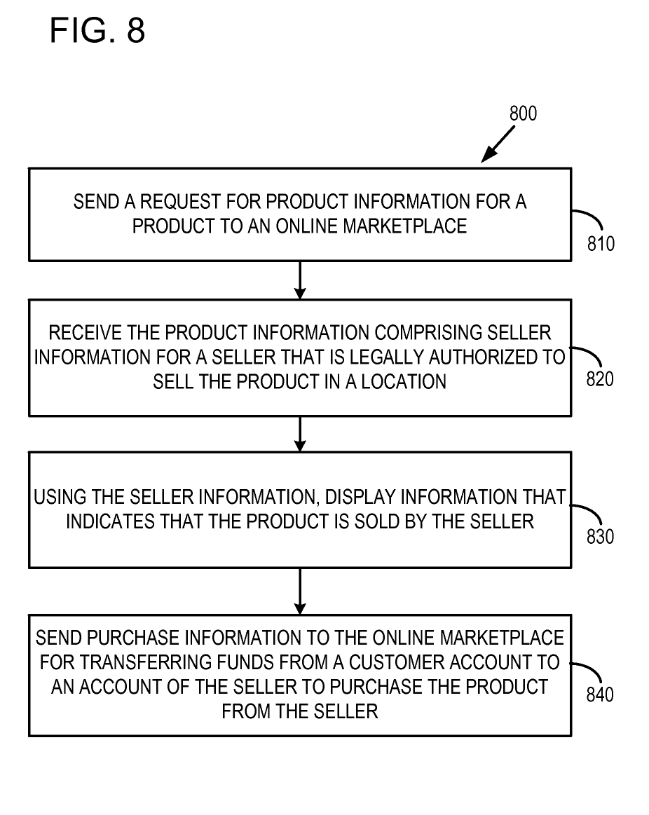

FIG. 8 is a flow diagram of an exemplary method 800 for purchasing a product from an identified seller by sending purchase information to an online marketplace. At FIG. 8, a request for product information for a product is sent to an online marketplace at 810.

At 820, the product information is received. For example, the product information is received responsive to sending the request for the product information. The product information includes seller information for a seller that is legally authorized to sell the product in a location where the product is for sale and/or being sold.

At 830, using the received seller information, information that indicates that the product is sold by the seller is displayed.

At 840, purchase information is sent to the online marketplace for transferring funds from a customer account to an account of the seller to purchase the product from the seller. For example, a customer that is using the device can provide financial information that can be used to transfer funds to the seller of the product from an account of the customer. In some implementations, the online marketplace does not own the funds that are transferred from the customer to the seller. An authorization to use the financial information of the customer can be included in the purchase information that is sent to the online marketplace to process a financial transaction for transferring funds for the sale of the product from the seller to the customer.

### Exemplary Mobile Device

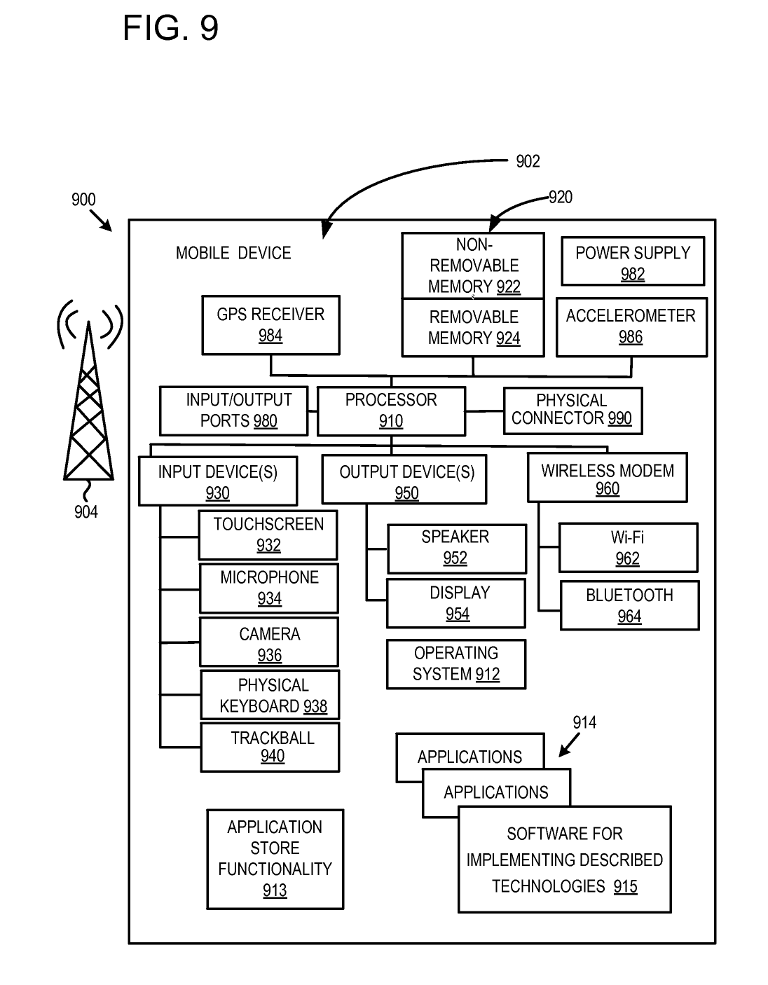

FIG. 9 is a system diagram depicting an exemplary mobile device 900 including a variety of optional hardware and software components, shown generally at 902. In general, a component 902 in the mobile device can communicate with another component, although not all connections are shown, for ease of illustration. The mobile device can be any of a variety of computing devices (e.g., cell phone, smartphone, tablet computer, handheld computer, Personal Digital Assistant (PDA), etc.) and can allow wireless two-way communications with one or more mobile communications networks 904, such as a cellular or satellite network.

The illustrated mobile device 900 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components 902 and support for one or more application programs 914 and/or one or more software programs 915 such as one that can implement one or more of the technologies described herein such as for facilitating the sale of a product for a seller through an online marketplace. The application programs can include common mobile computing applications and software (e.g., email applications, calendars, contact managers, web browsers, messaging applications, a runtime engine), or any other computing applications. Functionality 913 for accessing an application store, an online marketplace, or online provider can also be used for acquiring and updating code and/or other information for application programs 914.

The illustrated mobile device 900 can include memory 920. Memory 920 can include non-removable memory 922 and/or removable memory 924. The non-removable memory 922 can include RAM, ROM, flash memory, a hard disk, or other well-known memory storage technologies. The removable memory 924 can include flash memory or a Subscriber Identity Module (SIM) card, which is well known in GSM communication systems, or other well-known memory storage technologies, such as “smart cards.” The memory 920 can be used for storing data and/or code for running the operating system 912 and the applications 914 and 915. Example data can include web pages, text, images, sound files, video data, or other data sets to be sent to and/or received from one or more network servers or other devices via one or more wired or wireless networks. The memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 900 can support one or more input devices 930, such as a touchscreen 932, microphone 934, camera 936, physical keyboard 938 and/or trackball 940 and one or more output devices 950, such as a speaker 952 and a display 954. Other possible output devices (not shown) can include piezoelectric or other haptic output devices. Some devices can serve more than one input/output function. For example, touchscreen 932 and display 954 can be combined in a single input/output device. The input devices 930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 can comprise speech-recognition software as part of a voice user interface that allows a user to operate the device 900 via voice commands. Further, the device 900 can comprise input devices and software that allows for user interaction via a user's spatial gestures, such as detecting and interpreting gestures to provide input to a gaming application or other application.

A wireless modem 960 can be coupled to an antenna (not shown) and can support two-way communications between the processor 910 and external devices, as is well understood in the art. The modem 960 is shown generically and can include a cellular modem for communicating with the mobile communication network 904 and/or other radio-based modems (e.g., Bluetooth 964 or Wi-Fi 962). The wireless modem 960 is typically configured for communication with one or more cellular networks, such as a GSM network for data and voice communications within a single cellular network, between cellular networks, or between the mobile device and a public switched telephone network (PSTN).

The mobile device can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components 902 are not required or all-inclusive, as any components can deleted and other components can be added.

### Exemplary Implementation Environment

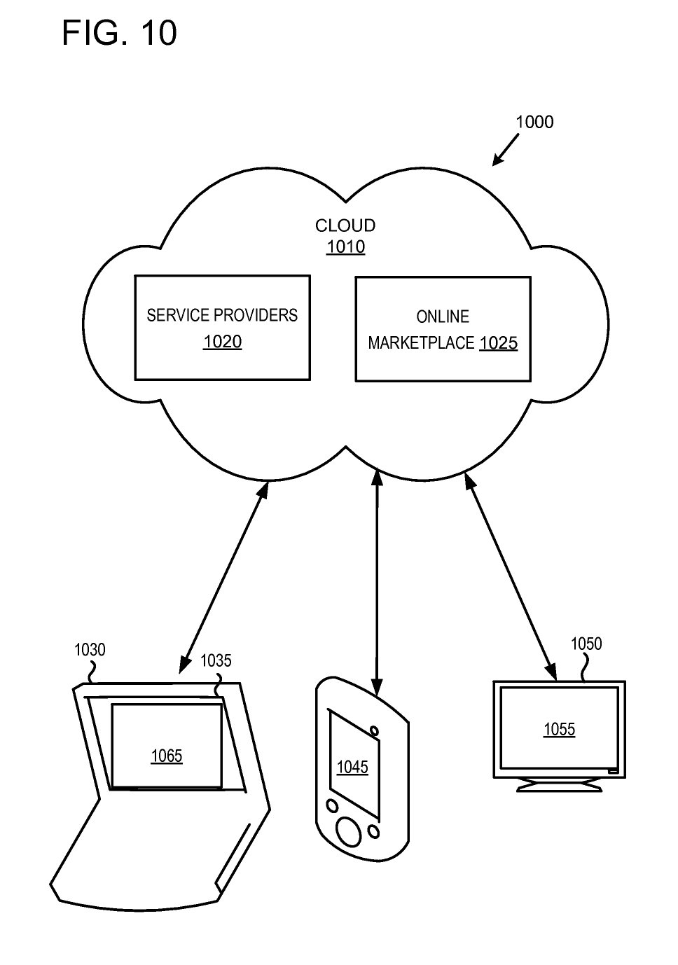

FIG. 10 illustrates a generalized example of a suitable implementation environment 1000 in which described embodiments, techniques, and technologies may be implemented.

In example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050) while other tasks (e.g., storage of data to be used in subsequent processing) can be performed in the cloud 1010.

In example environment 1000, the cloud 1010 provides services for connected devices 1030, 1040, 1050 with a variety of screen capabilities. Connected device 1030 represents a device with a computer screen 1035 (e.g., a mid-size screen). For example, connected device 1030 could be a personal computer such as desktop computer, laptop, notebook, netbook, or the like. Connected device 1040 represents a device with a mobile device screen 1045 (e.g., a small size screen). For example, connected device 1040 could be a mobile phone, smart phone, personal digital assistant, tablet computer, or the like. Connected device 1050 represents a device with a large screen 1055. For example, connected device 1050 could be a television screen (e.g., a smart television) or another device connected to a television (e.g., a set-top box or gaming console) or the like. One or more of the connected devices 1030, 1040, and 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Services can be provided by the cloud 1010 through service providers 1020, or through other providers of online services (not depicted). For example, cloud services can be customized to the screen size, display capability, and/or touchscreen capability of a particular connected device (e.g., connected devices 1030, 1040, 1050).

In example environment 1000, the cloud 1010 provides the technologies and solutions described herein to the various connected devices 1030, 1040, 1050 using, at least in part, the service providers 1020 and the one or more online marketplaces 1025. For example, the service providers 1020 can provide a centralized solution for various cloud-based services. The service providers 1020 can manage service subscriptions for users and/or devices (e.g., for the connected devices 1030, 1040, 1050 and/or their respective users). The cloud 1010 can provide resources for downloading, sending, or receiving requests or information from an online marketplace 1025 that can facilitate the sale of a product to customer for a seller. As shown at 1065, a seller is identified as being the seller of a product sold by the online marketplace 1025 of the cloud 1010.

### Exemplary Computing Environment

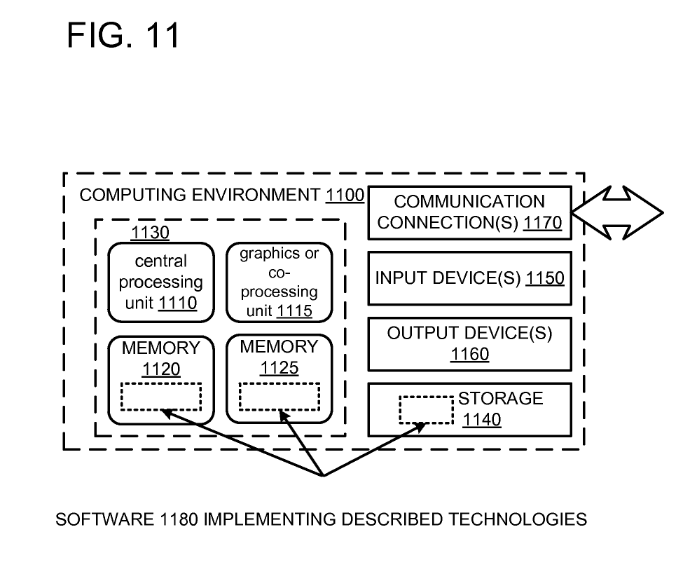

FIG. 11 depicts a generalized example of a suitable computing environment 1100 in which the described innovations may be implemented. The computing environment 1100 is not intended to suggest any limitation as to scope of use or functionality, as the innovations may be implemented in diverse general-purpose or special-purpose computing systems. For example, the computing environment 1100 can be any of a variety of computing devices (e.g., desktop computer, laptop computer, server computer, tablet computer, media player, gaming system, mobile device, etc.)

With reference to FIG. 11, the computing environment 1100 includes one or more processing units 1110, 1115 and memory 1120, 1125. In FIG. 11, this basic configuration 1130 is included within a dashed line. The processing units 1110, 1115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), nonvolatile memory (e.g., ROM, EEPROM, flash memory, etc.), or some combination of the two, accessible by the processing unit(s). The memory 1120, 1125 stores software 1180 implementing one or more innovations described herein, in the form of computer-executable instructions suitable for execution by the processing unit(s).

A computing system may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The tangible storage 1140 may be removable or non-removable, and includes magnetic disks, magnetic tapes or cassettes, hard disks, solid-state storage such as solid state drives, or optical disks such as CD-ROMs or DVDs. The storage 1140 stores instructions for the software 1180 implementing one or more innovations described herein such as for facilitating the sale of a product for a seller using an online marketplace.

The input device(s) 1150 may be a touch input device such as a keyboard, mouse, pen, or trackball, a voice input device, a scanning device, or another device that provides input to the computing environment 1100. For video encoding, the input device(s) 1150 may be a camera, video card, TV tuner card, or similar device that accepts video input in analog or digital form, or a CD-ROM or CD-RW that reads video samples into the computing environment 1100. The output device(s) 1160 may be a display, printer, speaker, CD-writer, or another device that provides output from the computing environment 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., computer-readable storage media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, C#, J++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionally described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims and their equivalents.

We claim:

1. A method comprising:
from a device, receiving a request for product information for a product;
determining the product information, the determining the product information comprising:
determining that the product is for sale in a location;
determining a category of the product; and
sending, from an online marketplace, the product information comprising seller information for a seller that is legally authorized to sell the product in the location, the seller information comprising identification information for the seller.

2. The method of claim 1 further comprising:
by the online marketplace, processing a financial transaction for a sale of the product for the seller, the processing the financial transaction comprising:
receiving a request to purchase the product from the device in the location;
determining financial information for the seller of the product; and
authorizing the use of the financial information to conduct a transfer of funds to the seller.

3. The method of claim 2, wherein the transfer of funds comprises depositing the funds in an account of the seller as payment for the product.

4. The method of claim 2, wherein the transfer of funds is conducted by a payment service; and
wherein the processing of the financial transaction protects seller business information possessed by the online marketplace from access outside of the online marketplace.

5. The method of claim 1, wherein the online marketplace provides one or more services to the seller for facilitating the sale of the product, the one or more services comprising cataloguing the product, processing a financial transaction for the sale of the product, user authentication for access to the online marketplace, user authentication for a purchase of the product, distributing the product, or unlocking the product.

6. The method of claim 1, wherein the product is categorized based on a license for selling the product legally in the location; and
wherein the seller has the license for selling the product legally in the location.

7. The method of claim 2 further comprising, by the online marketplace, logging sale information for the sale of the product, the sale information being accessible to the seller and the online marketplace.

8. The method of claim 1 further comprising:
receiving a request for available payment instrument options for the seller; and
sending information for one or more payment instrument options available for the seller, the seller having one or more billing codes for one or more payment services associated with the one or more payment instrument options.

9. The method of claim 1, wherein the location can be a country or a city.

10. The method of claim 1 the product can be a game application or a non-game application.

11. The method of claim 1 further comprising sending a receipt for the sale of the product to a customer that purchased the product.

12. The method of claim 1, wherein the identification information is used to identify the seller of the product in a display of the device.

13. The method of claim 1, wherein the online marketplace is a designated online marketplace for the device and the online marketplace provides a common look and feel for selling one or more products for one or more sellers.

14. The method of claim 1 further comprising categorizing the products at the online marketplace based on one or more conditions for selling the product, the one or more conditions for selling the product comprising a license for selling the product in the location or a law that regulates the sale of the product.

15. A computing device that includes a processor and computer readable media, the computer readable media storing computer-executable instructions for causing the system to perform a method, the method comprising:
sending, to an online marketplace, a request for product information for a product;
receiving, from the online marketplace, the product information comprising seller information for a seller that is legally authorized to sell the product in a location;
using the seller information, displaying information that indicates that the product is sold by the seller;
sending purchase information to the online marketplace for transferring funds to an account of the seller to purchase the product from the seller.

16. The computing device of claim 16, wherein the information that indicates that the product is sold by the seller is displayed in a product information screen.

17. The computing device of claim 16, wherein the seller information comprises information identifying a license the seller possesses to sell the product.

18. The computing device of claim 16, wherein the information that indicates that the product is sold by the seller is displayed in a product purchase screen.

19. The method of claim 16, further comprising displaying, in a purchase confirmation screen, information that identifies the seller and that indicates the product is sold by the identified seller.

20. One or more computer-readable storage media storing computer-executable instructions for causing a computing system to perform a method, the method comprising:
from a device located in a country, receiving at an online marketplace, a request for product information for a product;
by the online marketplace, determining the product information, the determining the product information comprising:
determining that the product is for sale in the country where the device is located;
determining a category of the product, wherein the category of a product is a game application that is sellable in the country with at least a first license or a non-game application that is sellable in the country with at least a second license;
from the online marketplace, sending, to the device for display, the product information comprising seller information for a seller that is legally authorized to sell the product in the country, the seller information comprising identification information for the seller;
by the online marketplace, facilitating a financial transaction for a sale of the product as part of a service for the seller, the processing the financial transaction comprising:
receiving a request to purchase the product from the device, the request including purchase information for a consumer;
responsive to receiving the request to purchase the product, determining a billing code of the seller, the billing code issued to the seller by a payment service; and
authorizing the use of the billing code to have the payment service transfer funds to an account of the seller as payment for the sale of the product.
